(19) United States
(12) Patent Application Publication
(10) Pub. No.: US 2025/0162919 A1
(43) Pub. Date: May 22, 2025

(54) SYSTEM AND PROCESS FOR TREATMENT OF PRODUCED WATER

(71) Applicant: Cavitation Technologies, Inc., Chatsworth, CA (US)

(72) Inventors: Roman Gordon, Studio City, CA (US); Naum Voloshin, Los Angeles, CA (US)

(73) Assignee: Cavitation Technologies, Inc., Chatsworth, CA (US)

(21) Appl. No.: 18/956,656

(22) Filed: Nov. 22, 2024

Related U.S. Application Data
(60) Provisional application No. 63/602,150, filed on Nov. 22, 2023.

(51) Int. Cl. C02F 9/00; C02F 1/00; C02F 1/24; C02F 1/34; C02F 1/44; C02F 1/461; C02F 1/467; C02F 101/30; C02F 103/10; E21B 43/34

(52) U.S. Cl. CPC C02F 9/00; E21B 43/35; C02F 1/004; C02F 1/24; C02F 1/34; C02F 1/441; C02F 1/46109; C02F 2001/46138; C02F 1/4672; C02F 2101/30; C02F 2103/10; C02F 2201/005

(57) ABSTRACT

An inventive system and method for treatment of contaminated produced water from fracking operations. The inventive system includes a filtration unit, an electrolysis unit, and a cavitation unit. The filtration unit may comprise mesh filtration units or reverse osmosis filtration units. The electrolysis unit may include alternative anode and cathode plates, where the anode plates have a mixed metal oxide coating. Each of the filtration, electrolysis, and cavitation units preferably comprise two or more of each arranged in parallel, such that each can be operated independently without stopping the operation of the entire system. The system and method may further include separation tanks and/or dissolved air flotation tanks—either before or after the electrolysis unit or cavitation unit processing.

### FIELD OF THE INVENTION

The present invention is directed to system and process for purifying industrial contaminated water. Specifically, the invention is directed to a cavitation reactor water treatment system optionally provided in concert with electrolysis to purify produced water resulting from hydraulic fracturing and similar petroleum extraction processes.

### BACKGROUND OF THE INVENTION

In mining methods such as hydraulic fracturing (commonly known as fracking) used in the extraction of oil and gas, “produced water” emerges as a byproduct. This water is naturally occurring within the geological formations where oil and gas reside. During fracking, high-pressure fluids, including water mixed with chemicals and/or sand, are injected deep into the earth to fracture the rock and release trapped hydrocarbons. As these fluids travel through the rock formations, they mix with the naturally occurring water present there, bringing it to the surface along with the extracted oil and gas. This water, often referred to as “produced water” or flowback water, is a combination of the injected fluids and the water naturally present in the underground formations.

Produced water contains various elements, including salts, minerals, hydrocarbons, and potentially harmful chemicals introduced during the fracking process. The composition can vary significantly depending on the geological characteristics of the site and the specific fracking techniques used. Once extracted, this water needs to be treated and managed properly due to its complex and often contaminated nature. Its handling requires specialized treatment to remove pollutants, reduce toxicity, and minimize environmental impacts before disposal or potential reuse. The large volumes of produced water generated during fracking operations pose challenges for safe disposal or recycling, necessitating stringent regulatory frameworks and advanced treatment technologies to mitigate environmental risks.

Efforts are continually made within the oil and gas industry and regulatory bodies to improve the treatment, disposal, and potential reuse of produced water. Advanced technologies and research focus on developing more efficient and environmentally friendly treatment methods to reduce the potential environmental impact associated with the disposal of this byproduct from mining activities like hydraulic fracturing.

“Produced water” from fracking can be potentially dangerous due to its complex composition and the presence of various contaminants. Several factors contribute to its potential hazards. One is the resultant chemical constituents contained in produced water. The water extracted during fracking contains not only naturally occurring elements from the geological formations but also chemicals added during the fracking process. These can include toxic substances used in the fracking fluid, such as biocides, corrosion inhibitors, and surfactants. Exposure to these chemicals, even in trace amounts, can pose health risks to humans, animals, and the environment.

Another factor is the presence of radioactive materials. Some geological formations where fracking occurs naturally contain radioactive materials. These can be brought to the surface along with the produced water. Elements like radium and uranium can pose significant health risks if not properly handled and disposed of.

Another concern related to produced water is the salinity and minerals therein. Produced water often has high salinity and contains various minerals and metals dissolved from the rock formations. When released into the environment, produced water can affect soil quality, harm vegetation, and contaminate water sources.

The greatest drawbacks to generating produced water may be the accompanying volume and disposal challenges. Fracking operations generate large volumes of produced water. Managing and disposing of this water in an environmentally safe manner poses significant challenges. Improper handling or accidental spills can lead to widespread environmental contamination.

The complexities of the composition, combined with the potential for large-scale environmental impact if not handled carefully, contribute to the concerns about the dangers associated with produced water from fracking. Proper treatment, management, and disposal of this byproduct are crucial to mitigate these risks and ensure the protection of human health and the environment.

Current methods for treating “produced water” from fracking tend to rely on chemical additives due to the complexity and contamination levels of the water. Several factors contribute to the need for these additives.

Produced water often contains emulsions—mixtures of oil and water—that are challenging to separate. Chemicals called demulsifiers are added to break these emulsions, allowing for easier separation of oil and water phases. Without demulsifiers, the separation process becomes inefficient and less effective.

Another major factor is the need for flocculants and coagulants. To remove suspended solids, heavy metals, and other contaminants from produced water, chemicals like flocculants and coagulants are added. These substances encourage the aggregation of smaller particles into larger clumps, aiding in their removal through filtration or sedimentation processes.

Another concern is the need for pH adjustment during the treatment process. Adjusting the pH of produced water is often necessary to optimize the effectiveness of treatment processes. Chemicals like acids or bases are added to achieve the desired pH level for the subsequent removal of contaminants or for better performance of specific treatment methods.

Finally, disinfection and sterilization requirements tend to increase the need for additives. Produced water may contain bacteria, microbes, or organic matter that can pose health risks. Chemical disinfectants or sterilizers are used to kill or neutralize these microorganisms, ensuring that the treated water meets safety standards for discharge or potential reuse.

While these chemical additives play crucial roles in purifying produced water, their use raises concerns about potential environmental impacts. Some chemicals used in the treatment process can be toxic or persistent, leading to issues if not properly managed during disposal. Efforts are ongoing to develop more sustainable and environmentally friendly treatment methods that reduce reliance on potentially harmful chemical additives.

Dissolved Air Flotation (DAF) systems are widely used in treating produced water and wastewater in various industries, including fracking. However, these systems have significant limitations.

DAF systems have reduced effectiveness with high chemical loads. DAF systems can struggle to efficiently treat water with high concentrations of chemicals or surfactants. These substances can interfere with the formation and stability of air bubbles used for flotation, reducing the system's effectiveness in removing contaminants.

DAF systems can be an inadequate treatment method for smaller particles. DAF systems work well for larger particles or contaminants that can form flocs or clusters, allowing them to rise and be removed. However, they may be less effective in removing smaller particles or colloidal matter that doesn't easily clump together, requiring additional or alternative treatment steps.

DAF systems have great chemical dependency for optimization. Achieving optimal performance with DAF systems often requires careful dosing and selection of chemicals like coagulants, flocculants, and pH adjusters. Managing these chemicals and their dosages can be complex and can vary depending on the composition of the produced water, making consistent performance challenging.

DAF systems also have substantial space and energy requirements. DAF systems can be relatively large and require substantial space for installation and operation. Additionally, they consume energy, particularly for the generation of microbubbles or for maintaining the required pressure levels, which can add to operational costs.

DAF systems can also experience issues with clogging due to the accumulation of solids or contaminants. Regular maintenance, including cleaning and monitoring, is necessary to prevent system fouling and ensure consistent performance.

DAF systems have limited efficacy in treating certain chemicals. Some specific contaminants, such as certain organic compounds or dissolved solids, might not be effectively removed by DAF alone, requiring additional treatment steps or alternative technologies.

Improvements in DAF technology are ongoing to address these limitations, focusing on enhancing efficiency, reducing chemical dependency, improving particle removal, and minimizing energy consumption. Integration with complementary treatment processes or the use of advanced filtration techniques aims to overcome the shortcomings of traditional DAF systems for purifying produced water

For the foregoing reasons, a great need exists for technologies that improve processing of produced water and aim to reduce the need for extensive chemical treatments in produced water. Further there is great need for methods that enhance efficiency, reduce chemical dependency, improve particle removal, and minimizing energy consumption.

The present invention fulfills these needs and provides other related advantages.

### SUMMARY OF THE INVENTION

The present invention is directed to a system and method for the treatment of contaminated water, particularly produced water. In particular, the inventive system and method relates to the use of hydrodynamic cavitation, specifically low-pressure nano-cavitation (LPN) reactors, in the treatment of produced water. Such treatment has the benefit of greatly reducing or even eliminating the need to add chemicals in such treatment, in particular hydrogen peroxide. The foregoing treatment also has the benefit of greatly reducing or eliminating the presence of sulfur and similar compounds in contaminated water. Such LPN reactor treatment of produced water can also be performed with the use of electrolysis treatment.

In addition, the cavitation treatment of contaminated water comprising entrained oil facilitates the separation of the same. The separation of oil from contaminated water by the cavitation process is of benefit to existing separation processes such as settlement tanks and DAF tanks. The separation of oil and water by cavitation processing works well on its own. However, the benefits of separation resulting from cavitation processing works best when applied before other separation systems, such as settlement tanks and/or DAF tanks. The cavitation processing advances the separation of oil and water such that other processes such as settlement and DAF are more effective than without cavitation processing.

The present invention is directed to a system for treating produced water from fracking operations. The system includes a filtration unit, an electrolysis unit, and a low-pressure nano-cavitation reactor. The filtration unit is configured to remove solid particles and suspended matter from the produced water. The electrolysis unit is configured to apply an electric current to filtered produced water from the filtration unit to break down organic compounds and kill microorganisms. The low-pressure nano-cavitation reactor is configured to treat electrolyzed produced water from the electrolysis unit by subjecting it to rapid pressure changes, thereby disrupting remaining organic compounds and microbial cell walls.

The filtration unit may comprise two or more mesh filtration units having a parallel fluid connection. The parallel fluid connection of the two or more mesh filtration units includes separate flow valves for each of the two or more mesh filtration units providing for independent operation.

The filtration unit may comprise two or more reverse osmosis filtration units having a parallel fluid connection. The parallel fluid connection of the two or more reverse osmosis filtration units includes separate flow valves for each of the two or more reverse osmosis filtration unit providing for independent operation.

The electrolysis unit may comprise a housing made from a clear or transparent plastic material formed in an elongated cylindrical chamber enclosing electrolysis conductors. Such housing may be made from unplasticized polyvinyl chloride. The electrolysis conductors may comprise an inner copper rod coextensive with a conductive rod comprising metal electrodes made from aluminum or iron.

Alternatively, the electrolysis conductors may comprise a pair of inner copper rods separately entering the electrolysis unit from opposite ends and in electrical contact with a first end plate conductor and a second end plate conductor. The electrolysis conductors may further comprise alternating anode plate conductors and cathode plate conductors, wherein the anode plate conductors are in electrical contact with the first end plate conductor and the cathode plate conductors are in electrical contact with the second end plate conductors. The anode plate conductors are preferably made from aluminum or iron coated with a mixed metal oxide and the cathode plate conductors are preferably made from uncoated aluminum or iron.

The electrolysis unit may comprise two or more electrolysis units having a parallel fluid connection. The parallel fluid connection of the two or more electrolysis units may include separate flow valves for each of the two or more electrolysis units providing for independent operation.

The system may further comprise a dissolved air flotation tank between the filtration unit and the electrolysis unit, or after the low-pressure nano-cavitation reactor.

The present invention is also directed to a method for treating produced water from fracking operations. The method steps include filtering the produced water through a filtration unit configured to remove solid particles and suspended matter from the produced water. The method steps further include applying an electric current to filtered produced water from the filtration unit in an electrolysis unit to break down organic compounds and kill microorganisms. The method steps further include cavitating electrolyzed produced water from the electrolysis unit in a low-pressure nano-cavitation reactor by subjecting the electrolyzed produced water to rapid pressure changes, thereby disrupting remaining organic compounds and microbial cell walls.

The filtering step may comprise two or more mesh filtration units having a parallel fluid connection, wherein the parallel fluid connection of the two or more mesh filtration units includes separate flow valves for each of the two or more mesh filtration units. The method further includes the step of operating the two or more mesh filtration units independently by selectively changing the flow valves.

Alternatively, the filtering step may comprise two or more reverse osmosis filtration units having a parallel fluid connection, wherein the parallel fluid connection of the two or more reverse osmosis filtration units includes separate flow valves for each of the two or more reverse osmosis filtration unit. The method further includes the step of operating the two or more reverse osmosis filtration units independently by selectively changing the flow valves.

The applying step may comprise an electrolysis unit enclosing electrolysis conductors consisting of a pair of inner copper rods separately entering the electrolysis unit from opposite ends and in electrical contact with a first end plate conductor and a second end plate conductor. The electrolysis unit further includes alternating anode plate conductors and cathode plate conductors, wherein the anode plate conductors are made from aluminum or iron coated with a mixed metal oxide and cathode plate conductors made from uncoated aluminum or iron. The anode plate conductors are in electrical contact with the first end plate conductor and the cathode plate conductors are in electrical contact with the second end plate conductors.

The applying step may comprise two or more electrolysis units having a parallel fluid connection, wherein the parallel fluid connection of the two or more electrolysis units includes separate flow valves for each of the two or more electrolysis units. The method further includes the step of operating the two or more electrolysis units independently by selectively changing the flow valves.

The method further comprises the step of separating contaminants from the filtered produced water in a dissolved air flotation tank between the filtering step and the applying step. Alternatively, the method further comprises the step of separating contaminants from the electrolyzed produced water in a dissolved air flotation tank after the cavitating step.

In the system and method for treatment of contaminated water, particularly produced water from fracking operations, cavitating operations are preferably carried out using a low-pressure nano-cavitation (LPN) reactor. Such cavitating operations serve to reduce or eliminate the need to add chemicals, such as hydrogen peroxide (H2O2) in the treatment of produced water; reduce or eliminate the presence of sulfur and similar compounds; and facilitate separation of entrained oil from produced water.

The electrolysis units or reactors function by passing electric current through the produced water to destabilize and remove suspended solids, emulsified oils, heavy metals, and other pollutants. The electrodes are preferably metal, i.e., aluminum or iron, immersed in produced water. When under current, the electrodes result in anodic dissolution of the metals —forming hydroxides. The pollutants in the produced water are removed by sorption, coagulation, and similar processes in the spaces between the electrodes. The ions act as coagulants and flocculants for pollutants and dissolved substances, so as to destabilize contaminants by neutralizing charges, cause the contaminants to clump together (flocs), where flocs are easier to remove through settling or filtration.

Operation of the electrolysis units can be improved by varying parameters such as current density, electrode material, pH, and reaction time to target specific components and improve efficiency. Such electrolysis helps to remove chromaticity, hydrogen sulfide, and/or ammonium pollutants. It also destroys chloramines by converting them to nitrogen and salts. The oxidative treatment of water is achieved through oxidizers made from the water itself and not by addition from outside. Chlorine already present is activated from natural mineral salts in the produced water so as to prevent secondary bacterial contamination. Preferably, the electrolysis units include anodes that are coated with high-quality industrial mixed metal oxide (MMO), which coating promotes both oxygen and chlorine evolution.

The alternate separation process of settlement tanks and DAF (dissolved air flotation) tanks are improved by the cavitation processing.

Other features and advantages of the present invention will become apparent from the following more detailed description, taken in conjunction with the accompanying drawings, which illustrate, by way of example, the principles of the invention.

### BRIEF DESCRIPTION OF THE FIGURES

The accompanying drawings illustrate the invention. In such drawings:

FIG. 1 is a front perspective view of an embodiment of a skid system embodying the water purification system depicting the filter unit and electrolysis unit;

FIG. 2 is a reverse angle view of the embodiment of the skid system of FIG. 1 depicting the filter unit and electrolysis unit, and adding the cavitation unit;

FIG. 3 is a perspective view of an electrolysis assembly separate from the skid system of FIG. 1;

FIG. 4 is perspective view of a pair of electrolysis cylinders fluidly connected separate from the assembly of FIG. 3;

FIG. 5 is a cross-sectional view of an embodiment of an electrolysis cylinder of the present invention;

FIG. 5A is a close-up of the cross-section of the electrolysis cylinder of FIG. 5 indicated by box 5A;

FIG. 6 is a cross-sectional view of an embodiment of an electrolysis cylinder of the present invention;

FIG. 6A is a close-up of the cross-section of the electrolysis cylinder of FIG. 6 indicated by box 6A;

FIG. 6B is a depiction of the internal electrodes of the electrolysis cylinder of FIG. 6;

FIG. 6C is a close-up of the internal electrodes of FIG. 6B indicated by box 6C;

FIG. 7A is a perspective view of an embodiment of a cavitation unit separate from the skid unit of FIG. 2;

FIG. 7B is a perspective view of an embodiment of a cavitation unit separate from the skid unit of FIG. 2;

FIG. 8 is a front perspective view of an alternate embodiment of a skid system embodying the water purification system of the present invention;

FIG. 9 is a front perspective view of an embodiment of an electrocoagulation unit from a skid system of the present invention;

FIG. 10 is an embodiment of a process flow diagram for a water treatment process embodying the present invention;

FIG. 11 is an alternate embodiment of a process flow diagram for a water treatment process embodying the present invention;

FIG. 12 is an illustration of a dissolved air flotation system of the present invention;

FIG. 13 is a table presenting test results of produced water quality for oil fields after being treated according to the present invention.

### DETAILED DESCRIPTION

Embodiments of the present disclosure comprise proprietary cavitation technology, either on its own or in conjunction with electrolysis, to provide a method for purifying produced water without (or reduced) chemical additives. Embodiments may be used in isolation or in concert with DAF systems to enhance the efficacy and reduce the ecological footprint of produced water treatment.

U.S. Pat. Nos.: 8,042,989, entitled Multi-State Cavitation Device, 7,762,715 entitled Cavitation Generator, 8,603,198 entitled High-throughput Cavitation and ElectroCoagulation Apparatus, 9,474,301, entitled Method and Flow Through Hydrodynamic Cavitational Apparatus for Alterations of Beverages, 10,507,442, entitled Variable Flow-Through Cavitation Device, 10,781,113 entitled System and Method for Purification of Drinking Water, Ethanol and Alcohol Beverages of Impurities, 10,876,084, entitled Method and Device for Producing of High Quality Alcoholic Beverages, 11,097,233, entitled Variable Flow-Through Cavitation Device, 10,876,085, entitled System and Method For Purification of Drinking Water, Ethanol and Alcohol Beverages of Impurities, 11,679,361, entitled Variable Flow-Through Cavitation Device, and 11,679,362, entitled Variable Flow-Through Cavitation Device, among others, describe various low-pressure nano-cavitation (LPN) reactor devices. Embodiments of the foregoing LPN cavitation systems generate cavitation through the formation and collapse of vapor bubbles in a liquid, in multiple stages to achieve various objectives.

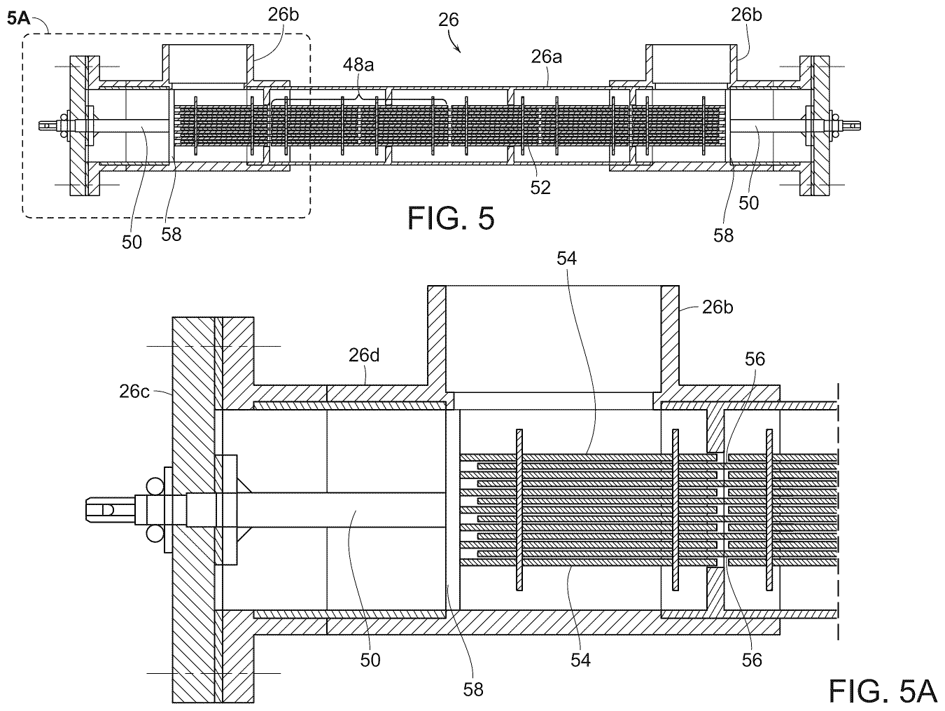

The LPN cavitation reactors, of the types shown in FIG. 5, comprise proprietary devices and formations to control and utilize cavitation for different purposes, potentially in industrial or fluid-processing applications. The cavitation patents disclose specific designs, configurations, and techniques to optimize cavitation effects for desired outcomes in a multi-stage setup including proprietary low pressure nano reactors (LPNRs).

Embodiments of the present disclosure utilize LPNR cavitation to trigger and accelerate numerous reactions and processes including advanced oxidation in water. While the supercritical effect is localized to the area of bubble collapse, there are three unique traits of supercritical cavitation in the water that can be used in produced water treatment: organic phases become completely soluble; oxygen is completely soluble and behaves as a strong oxidizer; and inorganic constituents become largely insoluble.

The shockwave released by many cavitation bubbles continuously collapsing. These forces can cause multiple chemical reactions, one of which is the dissociation of water into hydrogen and hydroxyl radicals. Hydroxyl radicals are powerful oxidizers and can be used to destroy organic constituents such as hydrocarbons.

Thus, cavitation by LPNR is a cost effective and environmentally friendly method for treating “produced water.” It is a chemical free process that is fully automated which greatly reduces waste to small dry amounts. Cavitation by LPNR can recycle one hundred percent of produced water from oil and gas drilling operations. Thus, the waste water, now purified “produced water” be reused in subsequent applications. Cavitation by LPNR may eliminate the use of chemicals in processing, some toxic, thereby reducing health, safety and environmental concerns associated with chemical consumption, transportation, and handling of biproducts from produced water treatment.

It has been observed that cavitation processing of produced water can reduce or completely eliminate the need to add chemicals such as hydrogen peroxide in the treatment of produced water, and still realize similar benefits as with full amounts of added chemicals like hydrogen peroxide. In addition, such cavitation processing can greatly reduce or completely eliminate the amounts of existing contaminants in produced water, particularly sulfur.

In addition, the cavitation processing facilitates the separation of oil from produced water. Such facilitated separation improves the performance and function of separation devices such as settlement tanks and/or DAF tanks. When cavitation treatment is provided before either or both of settlement tanks and DAF tanks, the degree of separation of oil from water achieved by either is greatly improved by the cavitation treatment.

These specific designs, configurations, and techniques are not intended to be limiting as to the novelty disclosed herein but rather representative of preferred and optional specific embodiments.

Industrial electrolysis is a water treatment method that uses an electrolytic process to remove contaminants from water. In the context of purifying “produced water” in fracking, electrolysis involves passing an electric current through the water to destabilize and remove suspended solids, emulsified oils, heavy metals, and other pollutants.

The process involves the use of metal electrodes (often aluminum or iron) immersed in the produced water. When an electric current is applied, these electrodes result in the anodic dissolution of metals that form their hydroxides and the pollutants are removed by sorption, coagulation, and other processes occurring in the space between the electrodes. These ions act as coagulants and flocculants, destabilizing contaminants by neutralizing charges and causing them to clump together. As the ions are released, they react with pollutants and dissolved substances, causing the formation of flocs (clusters of contaminants). These flocs are larger and easier to remove through settling or filtration processes.

The generated flocs settle out of the water or can be removed through filtration, allowing for the separation of purified water from the treated contaminants. Electrocoagulation systems can be adjusted for optimal performance by varying parameters such as current density, electrode material, pH, and reaction time to target specific contaminants and improve treatment efficiency.

The effectiveness of water disinfection by direct electrolysis is several times higher compared to chemical methods. Direct electrolysis of water helps to remove chromaticity, hydrogen sulfide, and/or ammonium from the source water. Direct electrolysis destroys chloramines, converting them into nitrogen and salt. Disinfection of water by direct electrolysis is a kind of oxidative treatment of water but is fundamentally different from the common methods of disinfection in that the oxidizers are made from the water itself, and are not introduced from the outside and, having fulfilled its function, go back to the previous state.

Chlorine, which is necessary to prevent secondary bacterial contamination of water in distribution networks, is activated from natural mineral salts in water passing through the electrolyzer and instantly dissolves in it. The difference between “direct electrolysis” and “production and accumulation of sodium hypochlorite” is that the use of special electrodes makes it possible to produce ozone and hydrogen peroxide from water.

During direct electrolysis, when the source water passes through the electrolyzer, oxidizers such as oxygen, ozone, hydrogen peroxide, sodium hypochlorite are synthesized, instantly showing their oxidative properties. Embodiments of the present invention use high quality industrial mixed metal oxides (MMOs) anodes for both oxygen and chlorine evolution to address the needed quality of water and the specific needs of operators. High pollutant removal yield from treated waters is achieved by using this proprietary method without adding any chemical coagulant or flocculants, thus reducing the amount of sludge.

This water treatment method and the system generate changes in the fluidic flow's velocity, pressure, temperature, voltage, resistance and chemical composition and physical properties to reduce the concentration of impurities. The simultaneous action of hydrodynamic cavitation, nano bubbles aeration, electrocoagulation and Electrooxidation formed in situ provide a unique synergistic effect that results in a highly efficient purification process.

These techniques are demonstrated as taught in the following patents: U.S. Pat. No. 8,673,129 High Throughput Cavitation and Electrocoagulation System; U.S. patent Ser. No. 10/507,442 Variable Flow-Through Cavitation Device; and U.S. patent Ser. No. 10/954,140. Cavitation with nano bubble aeration, and water electrolysis is the most effective technologies for the treatment of waters containing soluble organic compounds, can directly and indirectly oxidize small organic pollutants.

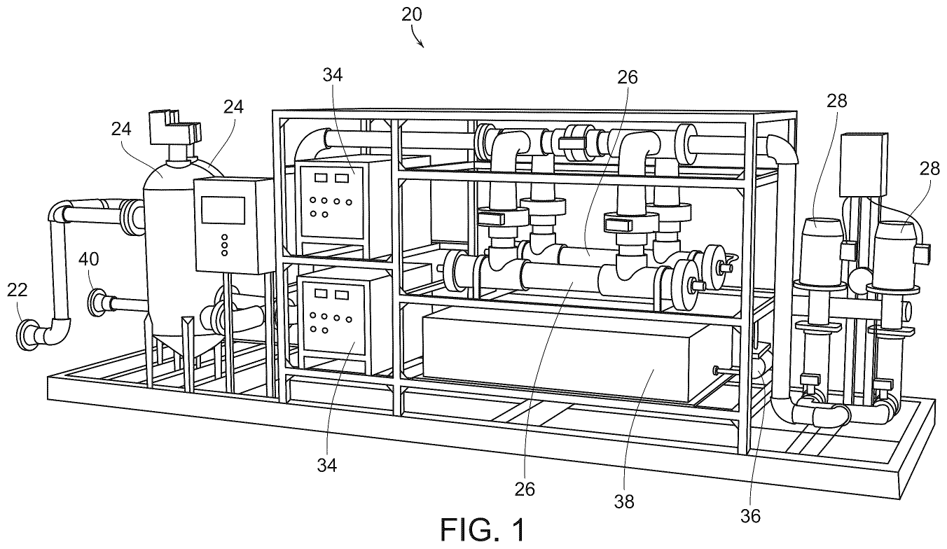

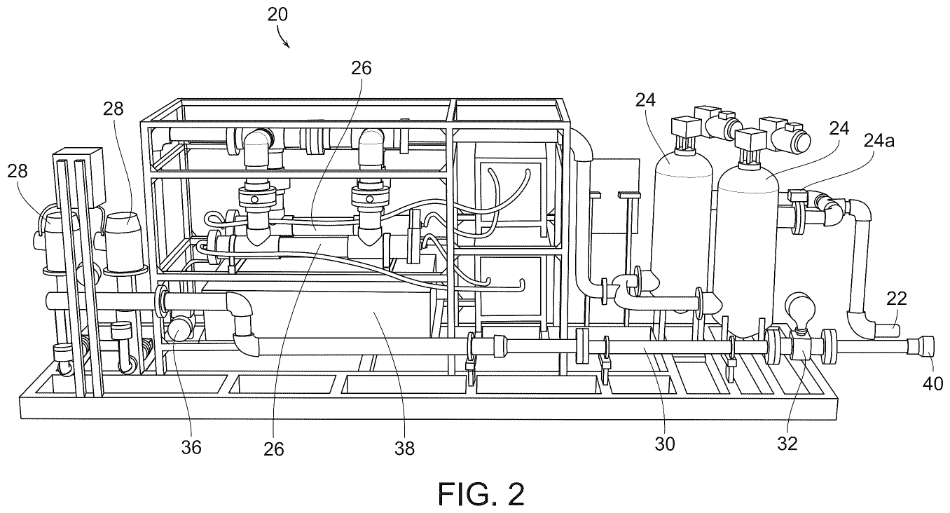

A water purification system (or system) is preferably installed on a skid or similar platform and may generally be referred to by reference character 20 as shown in FIGS. 1 and 2. The skid system 20 may generally comprise an intake 22 for produced water, one or more filtration units 24 with flow control valves 24a, one or more electrolysis units 26, one or more series of pumps 28, at least one low pressure nano reactor 30 and flow meter 32, as well as a plurality of control modules 34, an acid pump 36, an acid tank, and an outlet 40 for purified water to exit the skid system 20. The one or more filtration units 24 and one or more electrolysis units 26 may be installed in parallel or series, but preferably in parallel so that each may be used alternately and/or individually so as to facilitate cleaning and/or replacement as necessary without requiring the skid system 20 to be completely shut-down.

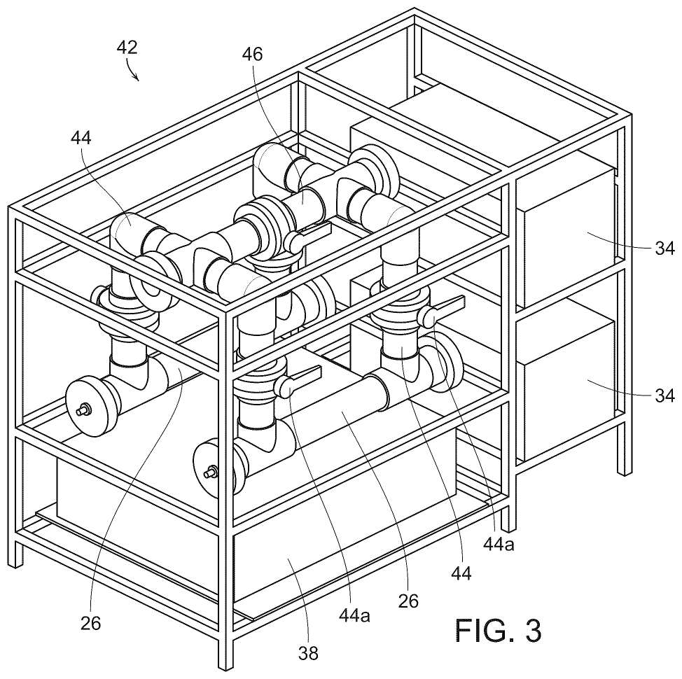

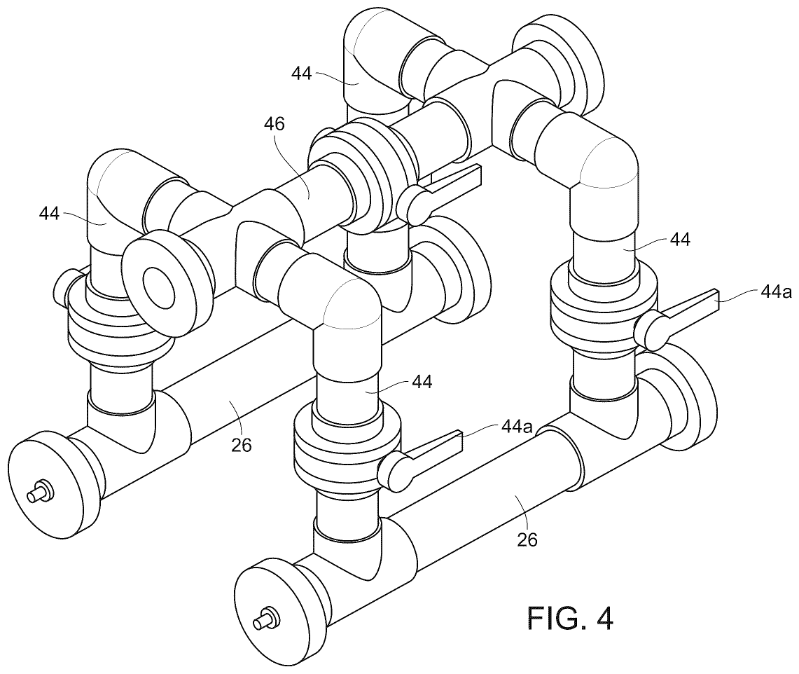

In FIG. 3, the electrolysis section 42 of the skid system 20 containing the electrolysis units 26 is shown in isolation from the rest of the skid 20. Further, in FIG. 4, the electrolysis units 26 and respective electrolysis fluid connecting pipes 44 are shown separate from the section. The connecting pipes 44 include flow control valves 44a and fluidly connect the electrolysis units 26 to a system flow pipe 46 that facilitates fluid connection of electrolysis section 42 to the skid system 20.

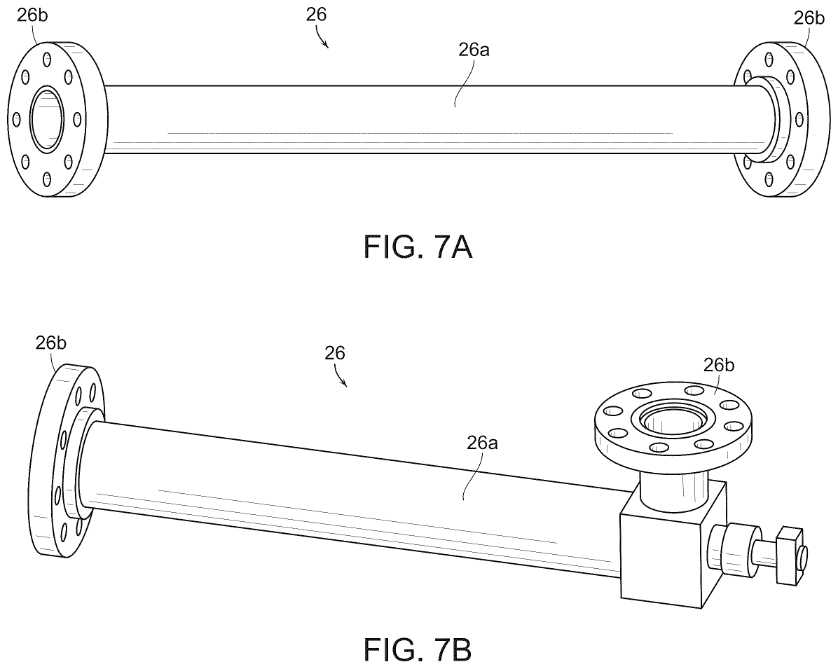

As shown in FIGS. 7A and 7B, an electrolysis unit 26 may comprise a cell housing 26a and pipe fitting 26b, preferably made of UPVC or other suitable materials in compliance with standard ANSI 6″ metrics. The frame of the electrolysis section 42 is preferably aluminum alloy 50-50 or material with similar structural, rigidity, and weight properties. The acid tank 38 may be made of suitable materials known in the art. The acid pump 36 flow rate is preferably 200 L/H and 0.6 MPA. A power supply specification may be set with a current output at less than 500 A, with output voltage at 40V.

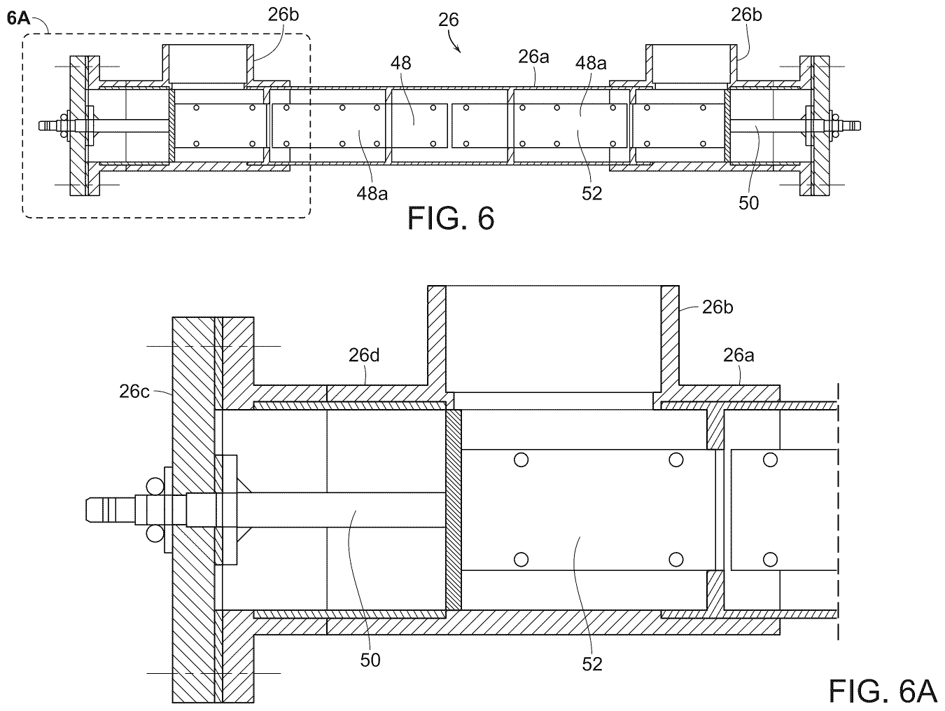

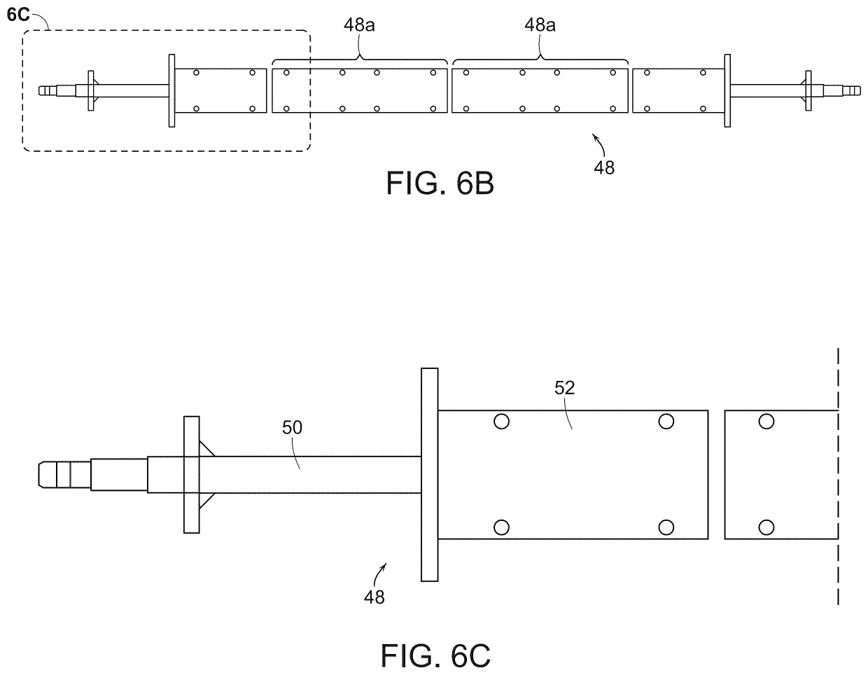

As shown in FIGS. 5, 5A, 6, 6A, 6B, and 6C, embodiments of the electrolysis units 26 may be presented in varying configurations. As mentioned above, the housing 26a is preferably a UPVC (unplasticized polyvinyl chloride) or similar material, formed as an elongated cylindrical chamber enclosing electrolysis conductors 48. In one embodiment (FIGS. 6, 6A, 6B, and 6C) an inner-most copper rod 50 may be coextensive with a conductive rod 52. The copper rod 50 and conductive rod 52 may be internal to the UPVC transparent housing 26a. External to and surrounding the UPVC transparent tube may be an outer casing comprising a UPVC flange 26b, UPVC cap 26c, and UPVC three directional link 26d.

In an alternate embodiment (FIGS. 5 and 5A), the electrolysis conductors 48 preferably comprise multiple electrolysis cells 48a, each comprising alternating anode plates 54 (i.e., 190 by 190-1.5 MM (total) plates) and cathode plates 56 (i.e., 360 by 90-1.5 mm (total) plates). The anode plates 54 may be coated with MMO (mixed metal oxides) and the cathode plates 56 are preferably uncoated. The inner-most copper rod 50 consists of two separate conductors, preferably entering the electrolysis unit 26 from each end, with each separate copper rod 50 in electrical contact with first and second end plate conductors 58 alternately in contact with either the anode plates 54 at a first end or the cathode plates 56 at the opposite end. All titanium tubing materials may be ASTM B265 grade standard material. In this embodiment of the electrolysis units 26, the nominal current density may preferably be 1200 AM. The designated production rate may preferably be 1200 G/H. The electrolysis units 26 inlet/outlet diameter is preferably DN150 (6 inches.) The cell flange housing 26a may be comprised of UPVC material. The electrolysis conductors 48 may use PTFE spacer and threading rods and nuts to fix distances between the adjacent plates 54 and 56.

In this embodiment of the present invention, the purification process includes proprietary technologies, unique stand-alone water treatment processes, hybrid configurations of commercial packages and patented systems developed for treatment of oil and gas produced water. This process includes proprietary nano bubble aeration pretreatment, nano cavitation and water electrolysis treatment and concentrated waste disposal to meet the required water quality standards Eliminating waste and harsh chemicals, reduces operational and man-power cost.

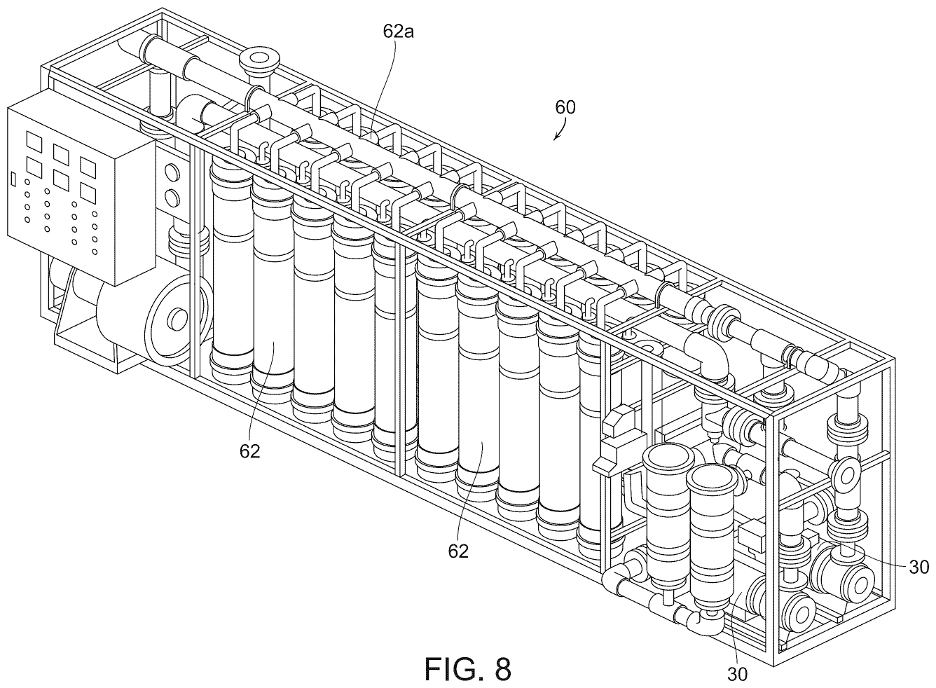

As shown in FIG. 8, an alternate embodiment of the present disclosure comprises a produced water reverse osmosis skid system 60 comprising a plurality of reverse-osmosis filtration units 62 (preferably arranged in parallel with corresponding flow control valves 62a) followed by one or more low pressure nano cavitation reactors 30. In this embodiment, multistage reverse osmosis filtration units 62 further facilitate treatment of produced water.

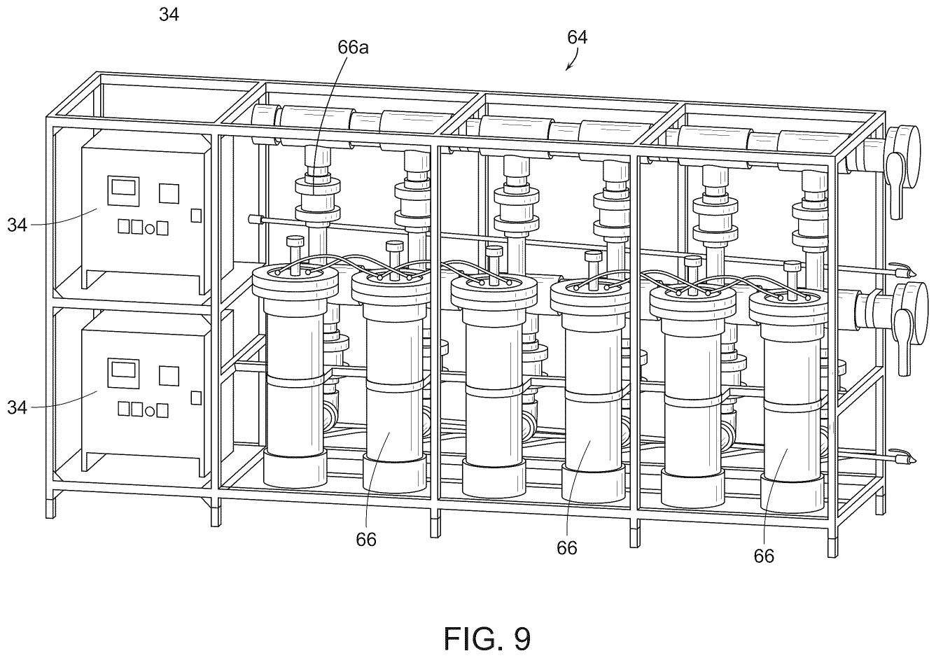

In this embodiment, as shown in FIG. 9, an electrocoagulation-electroflotation (ECF) skid system 64 may be utilized in conjunction with other systems. The ECF skid system 64 preferably includes a series of ECF units 66 arranged in parallel having corresponding flow control valves 66a with one or more control modules 34. ECF technology is a treatment process of applying electrical current to treat and flocculate contaminants without having to add coagulations. Coagulation occurs with the current being applied, capable of removing small particles since direct current applied, setting them into motion. ECF also reduces residue for waste production.

ECF systems comprise pairs of metal sheets called electrodes, that are arranged in pairs of two—anodes and cathodes. Using the principles of electrochemistry, the cathode is oxidized (loses electrons), while the water is reduced (gains electrons), thereby improving treatment of the wastewater. When the cathode electrode makes contact with the wastewater, metal ions are emitted into the wastewater. When this happens, the particulates are neutralized by the formation of hydroxide complexes for the purpose of forming agglomerates. These agglomerates begin to form at the bottom of the tank and can be siphoned out through separate filtration systems. However, when considering an ECF apparatus, the particulates would instead float to the top of a tank by operation of formed hydrogen bubbles that are created from the anode. The floated particulates can simply be skimmed from the top of the tank. Electrolysis, electrocoagulation and electrooxidation techniques are closely related in the art and reference to one may include the others and is not intended to exclude the others.

The inventive electrolysis-cavitation method may be performed in isolation or in conjunction with an ECF system and/or a DAF system so as to improve the efficiency thereof. When used with an ECF system and/or a DAF system, the electrolysis and cavitation may be applied in any order. In sequence, the order may vary as needed, i.e., electrolysis applied first followed by cavitation or cavitation applied first followed by electrolysis. In particularly preferred embodiments, electrolysis is applied first as shown in FIGS. 1 and 2. By applying sequenced cavitation and electrolysis to existing produced water purification techniques, the systems can purify produced water using reduced or eliminated chemical additives thereby reducing chemical cost with a much-reduced ecological and economic footprint.

The electrolysis and cavitation may occur prior to application of produced water to a DAF system or after produced water has been cleaned by a DAF system. When a DAF system is incorporated into water treatment, the electrolysis may be coupled to cavitation in sequence or uncoupled. Where electrolysis and cavitation are uncoupled in conjunction with a DAF system, electrolysis may precede the DAF system where the produced water is thereafter subjected to cavitation. In alternate configurations, cavitation may precede the DAF system where produced water is thereafter subjected to electrolysis.

In preferred DAF systems, the high-efficiency dissolved air flotation takes the treated effluent as circulating water through the circulating pump and the water flows into the dissolved air tank. At the same time, compressed air is added into the dissolved air tank, and efficient air-water mixing is carried out in the dissolved air tank. After mixing, the dissolved air water full of air is sent to the air flotation contact area, and then through the instantaneous pressure relief of the releaser. A large number of nano-sized microbubbles are generated, which are quickly attached to the coagulated suspension. The density of suspended solids is gradually less than that of water, and automatically floats to the surface, leaving clean water at the bottom of the equipment. At the bottom, it is discharged to the clean water area through the water outlet device.

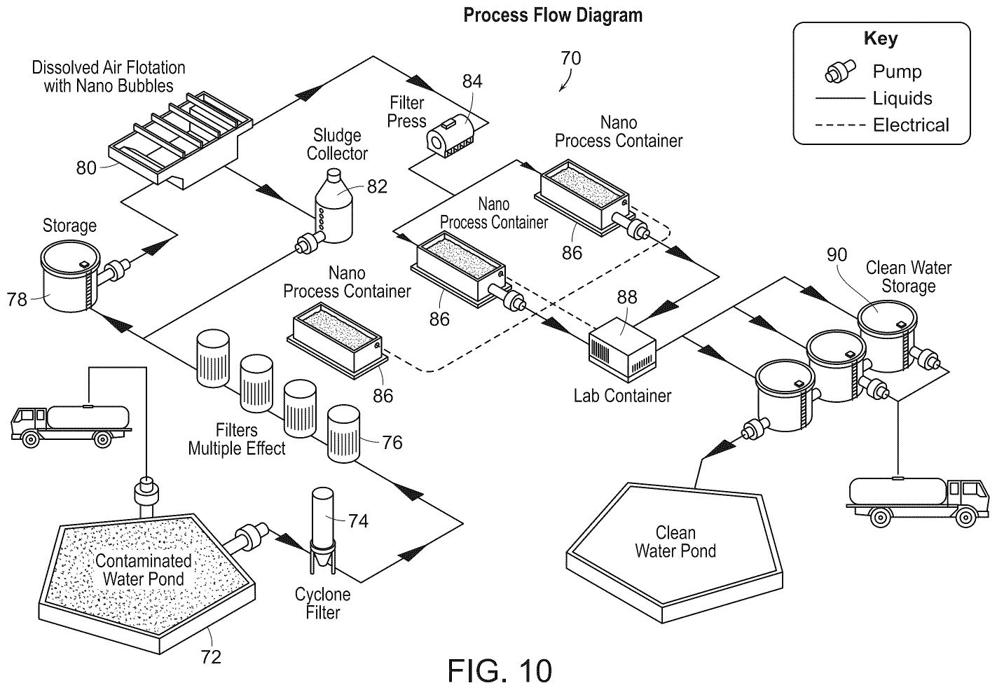

FIG. 10 schematically illustrates an overall process flow diagram for produced water treatment that combines DAF and cavitation processing. In this process 70, contaminated or produced water is held in a storage or contaminated water pond 72, as delivered by tanker trucks or other transportation means. From the pond 72, the produced water is processed through a cyclone filter 74 or similar to remove large particles. For additional large particle filtering the produced water is preferably also passed through a series of multiple effect filters 76, whereupon the produced water is added to a storage tank 78. From there, the produced water is introduced to a Dissolved Air Flotation (DAF) tank 80 including nano bubbles to facilitate flotation. A bottom from the DAF tank 80 is passed to a sludge collector 82, whereupon the removed material is recycled to the storage tank 78 for further processing.

The main outlet from the DAF tank 80 brings the produced water to a filter press 84 where further separation occurs. From the filter press 84, the produced water is further treated in one or more nano process containers 86, which are electrically controlled by a lab container 88. From the nano process containers 86, the produced water is now effectively clean water and passed to one or more clean water storage tanks 90 and then optionally to a clean water pond 90a.

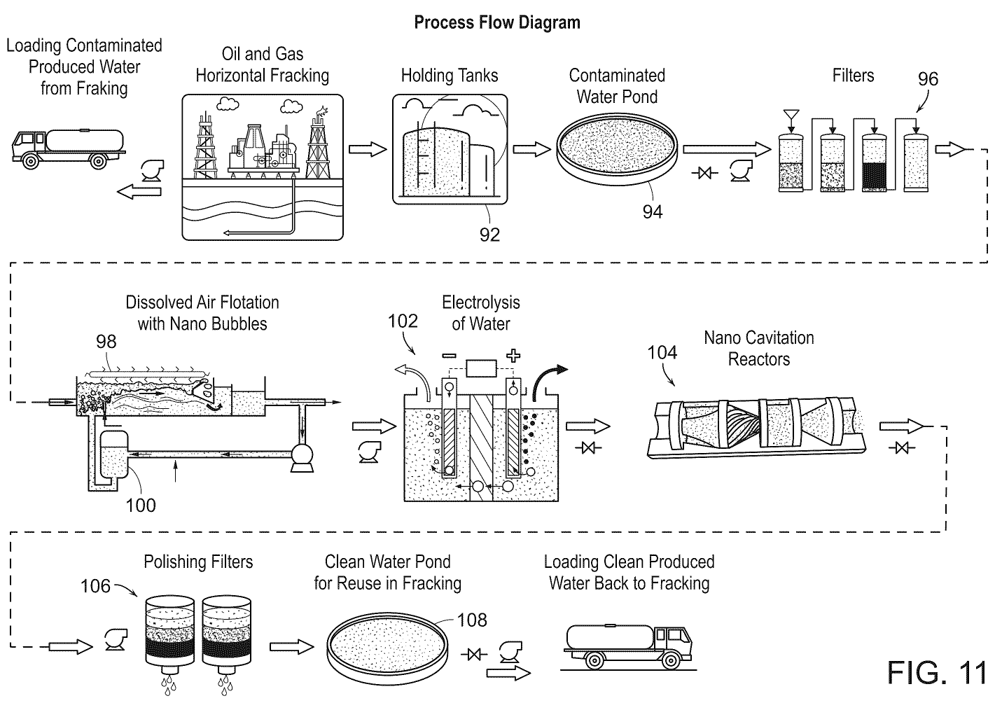

In FIG. 11, a process flow diagram for an improved treatment method is schematically illustrated. In this process, produced water from oil and gas fracking processes is placed in holdings tanks 92 and/or contaminated water ponds 94. From the tanks 92 and/or ponds 94, the produced water is pumped through as series of filtration units 96 designed to remove large particle contaminants. After such filtration, the produced water is next subjected to a DAF tank with nano bubbles 98 with similar bottom recycling as through a sludge 100 collected in the prior system. The produced water is then pumped into an electrolysis unit 102 as described above. The produced water is then subjected to treatment in one or more nano-cavitation reactors 104. After such treatment, the produced water is effectively cleaned, where the clean water is pumped through polishing filters 106 and then stored in a clean water pond 108 for storage. The cleaned water can then be re-used for fracking or other known uses for cleaned produced water.

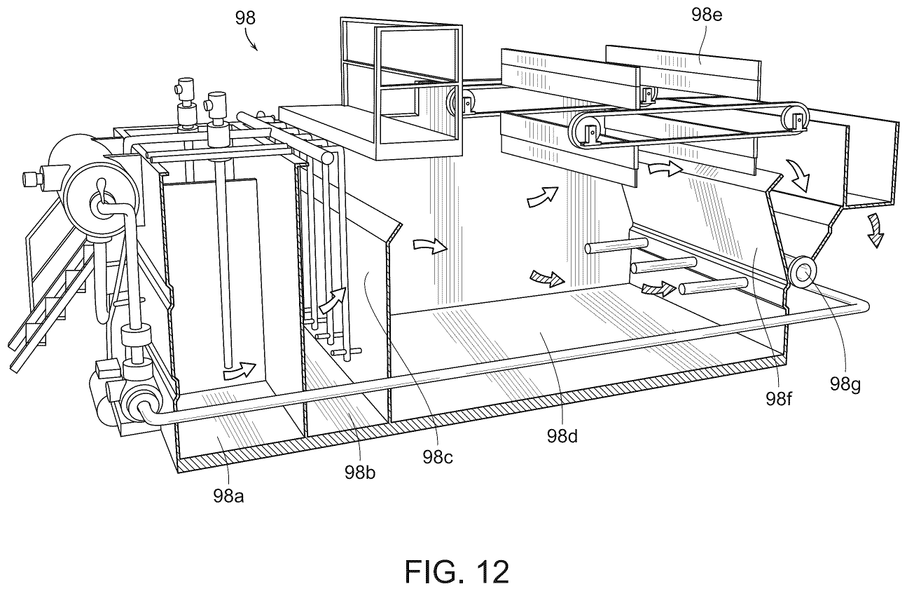

FIG. 12 illustrates an embodiment of a DAF tank with nano bubbles 98. In this tank 98, produced water is pumped into a first chamber 98a where nano bubbles are injected into the produced water and then a second chamber 98b where the nano bubbles are uniformly distributed through the produced water as by agitation. The produced water then overflows a lower barrier 98c into a main chamber 98d. In the main chamber 98d, the produced water with entrained nano bubbles is allowed to settle such that flocculant and flotation processes can proceed unhindered. In this main chamber 98d, contaminants clump together and float on bubbles to the surface of the produced water. A surface paddle or scraper 98e drags across the surface of the water and removes floating clumps. The remaining produced water passes over an outlet weir 98f whereupon it reaches effluent outlet 98g.

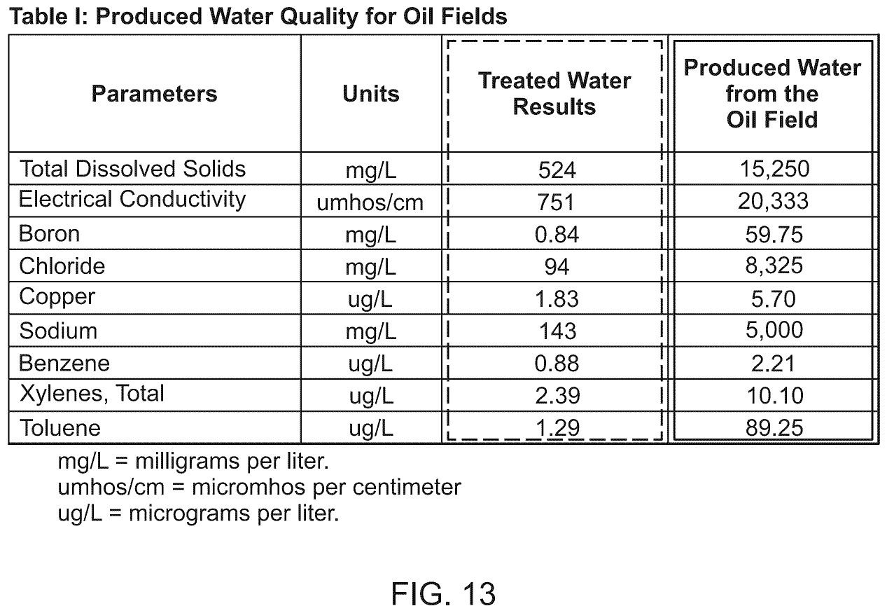

The table shown in FIG. 13 shows measurements of various contaminants in produced water from an oil field versus in clean water after treatment. These before-after results demonstrate the striking effectiveness of the instant invention. Total dissolved solids are reduced to less than ⅓ of the untreated amounts. The other contaminants demonstrate similar magnitudes of reduction.

Although several embodiments have been described in detail for purposes of illustration, various modifications may be made without departing from the scope and spirit of the invention.

1. A system for treating produced water from fracking operations, the system comprising:
a filtration unit configured to remove solid particles and suspended matter from the produced water;
an electrolysis unit configured to apply an electric current to filtered produced water from the filtration unit to break down organic compounds and kill microorganisms; and
a low-pressure nano-cavitation reactor configured to treat electrolyzed produced water from the electrolysis unit by subjecting it to rapid pressure changes, thereby disrupting remaining organic compounds and microbial cell walls.

2. The system of claim 1, wherein the filtration unit comprises two or more mesh filtration units having a parallel fluid connection, wherein the parallel fluid connection of the two or more mesh filtration units includes separate flow valves for each of the two or more mesh filtration units providing for independent operation.

3. The system of claim 1, wherein the filtration unit comprises two or more reverse osmosis filtration units having a parallel fluid connection, wherein the parallel fluid connection of the two or more reverse osmosis filtration units includes separate flow valves for each of the two or more reverse osmosis filtration unit providing for independent operation.

4. The system of claim 1, wherein the electrolysis unit comprises a housing made from a clear or transparent plastic material formed in an elongated cylindrical chamber enclosing electrolysis conductors.

5. The system of claim 4, wherein the housing is made from unplasticized polyvinyl chloride.

6. The system of claim 4, wherein the electrolysis conductors comprise an inner copper rod coextensive with a conductive rod comprising metal electrodes made from aluminum or iron.

7. The system of claim 4, wherein the electrolysis conductors comprise a pair of inner copper rods separately entering the electrolysis unit from opposite ends and in electrical contact with a first end plate conductor and a second end plate conductor.

8. The system of claim 7, wherein the electrolysis conductors further comprise alternating anode plate conductors and cathode plate conductors, wherein the anode plate conductors are in electrical contact with the first end plate conductor and the cathode plate conductors are in electrical contact with the second end plate conductors.

9. The system of claim 8, wherein the anode plate conductors are made from aluminum or iron coated with a mixed metal oxide and the cathode plate conductors are made from uncoated aluminum or iron.

10. The system of claim 1, wherein the electrolysis unit comprises two or more electrolysis units having a parallel fluid connection, wherein the parallel fluid connection of the two or more electrolysis units includes separate flow valves for each of the two or more electrolysis units providing for independent operation.

11. The system of claim 1, further comprising a dissolved air flotation tank, wherein the dissolved air flotation tank is between the filtration unit and the electrolysis unit, or after the low-pressure nano-cavitation reactor.

12. A method for treating produced water from fracking operations, comprising the steps of:
filtering the produced water through a filtration unit configured to remove solid particles and suspended matter from the produced water;
applying an electric current to filtered produced water from the filtration unit in an electrolysis unit to break down organic compounds and kill microorganisms; and
cavitating electrolyzed produced water from the electrolysis unit in a low-pressure nano-cavitation reactor by subjecting the electrolyzed produced water to rapid pressure changes, thereby disrupting remaining organic compounds and microbial cell walls.

13. The method of claim 12, wherein the filtering step comprises two or more mesh filtration units having a parallel fluid connection, wherein the parallel fluid connection of the two or more mesh filtration units includes separate flow valves for each of the two or more mesh filtration units, further comprising the step of operating the two or more mesh filtration units independently by selectively changing the flow valves.

14. The method of claim 12, wherein the filtering step comprises two or more reverse osmosis filtration units having a parallel fluid connection, wherein the parallel fluid connection of the two or more reverse osmosis filtration units includes separate flow valves for each of the two or more reverse osmosis filtration unit, further comprising the step of operating the two or more reverse osmosis filtration units independently by selectively changing the flow valves.

15. The method of claim 12, wherein the applying step comprises an electrolysis unit enclosing electrolysis conductors consisting of a pair of inner copper rods separately entering the electrolysis unit from opposite ends and in electrical contact with a first end plate conductor and a second end plate conductor, and alternating anode plate conductors made from aluminum or iron coated with a mixed metal oxide and cathode plate conductors made from uncoated aluminum or iron, wherein the anode plate conductors are in electrical contact with the first end plate conductor and the cathode plate conductors are in electrical contact with the second end plate conductors.

16. The method of claim 12, wherein the applying step comprises two or more electrolysis units have a parallel fluid connection, wherein the parallel fluid connection of the two or more electrolysis units includes separate flow valves for each of the two or more electrolysis units, further comprising the step of operating the two or more electrolysis units independently by selectively changing the flow valves.

17. The method of claim 12, further comprising the step of separating contaminants from the filtered produced water in a dissolved air flotation tank between the filtering step and the applying step.

18. The method of claim 12, further comprising the step of separating contaminants from the electrolyzed produced water in a dissolved air flotation tank after the cavitating step.
